(19) United States
(12) Patent Application Publication
(10) Pub. No.: US 2003/0218616 A1
(43) Pub. Date: Nov. 27, 2003

(54) BoxIT

(76) Inventor: Kenneth Dean Easterby, Mountain View, CA (US)

Correspondence Address: Kenneth Dean Easterby, 1669 Latham St., Mountain View, CA, 94041, US

(21) Appl. No.: 10/154,599

(22) Filed: May 24, 2002

(51) Int. Cl. G09G 5/00

(52) U.S. Cl. 345/619

(57) ABSTRACT

To create an image of a Macintosh computer, operating system and applications need to be installed in such a manner that the serial numbers for the operating system and applications are unique for each Macintosh computer so that there is no duplication of serial numbers.

The internal or external drive must be configured with partitions which are specific in size and configured using a specific disk partitioning utility.

The combination of unique installation of operating system and applications and the configuration of the internal or external hard drive make boxIT unique.

### BRIEF SUMMARY OF THE INVENTION

By utilizing a unique combination of free software and unique configuration of an external (or internal) hard drive I can transfer an image of a Macintosh computer to another Macintosh computer.

The advantages is that this process of transferring an image takes 60% less time than configuring a Macintosh computer using the traditional methods of inserting a cd and installing the software.

Saving time also saves money so this invention is a very big value to anyone who ownes a Macintosh computer.

### BACKGROUND OF INVENTION

The field of endeavor to which this invention pertains is to the field of Information Technology specific to the Macintosh Platform.

The current problem with the Macintosh platform is that it is impossible (before this invention) to create an exact image of a Macintosh Computer and transfer that image to another Macintosh computer.

Because of this problem I have created an invention which allows me to create an image of a Macintosh computer and transfer that image to another Macintosh computer.

1. I claim that no other person can create an image of a Macintosh computer in the manner which I can create an image of a Macintosh computer and that I can copy this image to another Macintosh computer faster than anyone else can.
